(19) United States
(12) Patent Application Publication
(10) Pub. No.: US 2009/0199204 A1
(43) Pub. Date: Aug. 6, 2009

(54) SYSTEMS AND METHODS FOR CONSTRUCTING PROTOCOL STATE MACHINES TO DETERMINE THE VALIDITY OF AN IMPLEMENTATION OF A SERVICE INTERFACE

(75) Inventor: Joachim H. Frank, Greenwich, CT (US)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/026,403

(22) Filed: Feb. 5, 2008

(51) Int. Cl. G06F 9/54

(52) U.S. Cl. 719/313

(57) ABSTRACT

A system is provided for constructing an implementation protocol given (a) a partner interaction protocol describing possible sequences of messages between two interacting parties, (b) one or more protocols of message exchange patterns of operations of a service interface, and (c) an implementation mapping that maps the input and output messages of the service interface to messages between the two interacting parties. The system includes at least one processor, and an implementation-protocol generating module that executes on the at least one processor. The implementation-protocol generating module is configured to generate a state-machine graph representing the partner interaction protocol, to generate at least one state-machine graph representing message exchange patterns corresponding to operations of the service interface, and to construct from the state-machine graphs an implementation protocol that defines which operations of the service interface are used for any sequence of message flows of the process role.

### FIELD OF THE INVENTION

The present invention is related to the field of data communications networks, and more particularly, to techniques for determining whether the possible sequences of electronic messages exchanged between two parties whose interaction behavior is described using either a multi-party process model or protocol state machine complies with the message exchange pattern of a given service interface.

### BACKGROUND OF THE INVENTION

Partner interactions in a business-to-business (B2B) scenario can be describecd by a process model, wherein each partner's role is represented by a process segment or “swim lane.” Alternatively, partner interactions can be described using a protocol state machine. More specifically, message exchanges between two or more participants to a transaction conducted over a data communications network, such as the Internet or other data communications network, can be described or represented by a process model comprising process segments corresponding to each participant's role in the transaction. In this (process based) representation, edges (or “flows”) in the process graph that cross segment boundaries represent messages that different participants may exchange during the transaction. In a state machine representation of a partner interaction protocol, such messages are represented by state transitions.

To participate in electronic multi-party interactions (for example, in the context of a Service Oriented Architecture) the interacting parties must often either publish an interface for a service they already implemented, or implement a service according to a predefined interface specification. Service interfaces are commonly represented using an interface specification language, such as the XML-based Web Services Description Language (WSDL).

When one partner (“the service”) publishes a service description with which other partners must comply, the service description implies certain constraints on the type and sequencing of messages exchanged between the service and its clients. The issue thus arises whether the interaction between two roles described by a process model or protocol state machine complies with a given service interface for one of the two roles. For example, the question may arise whether a partner implementation that behaves in accordance with some role in the process model is a valid implementation of the service interface.

Addressing the issue requires a sufficiently precise definition of compliance. Preliminarily, if the partner interaction behavior is described by a process model, a mapping from input and output messages in the service interface to inbound and outbound flows for a role in the process model—that is, flows into and out of a swim lane—is needed. A process role can be said to comply with a service interface under this mapping if the following conditions hold: (i) the mapping preserves flow directions; (ii) the mapping preserves message type conformance; and (iii) the mapping guarantees message sequencing compliance. Such a mapping is referred to herein as an “implementation mapping”, since it associates actual message flows of the implementation (here given as the process model) with the abstract specifications of such messages in interface operations.

If the partner interaction behavior is given by a protocol state machine, the implementation mapping maps input and output messages of the service interface to state transitions of the protocol (which in turn represent messages exchanged between the interacting parties).

Exception or fault messages defined in the interface are, depending on their direction, considered special-purpose input or output messages. Thus, any references to input or output messages of the service interface implicitly include messages designated as faults or exceptions.

Preserving message directions requires that input messages of the service interface are mapped to flows into the selected role, and output messages of the service interface to flows leaving the selected role. Determining whether this condition is satisfied is straightforward.

Message-type conformance requires that the type of an input message in the service interface conforms to the type of the flow into the selected role to which it has been mapped, and that the type of a flow leaving the selected role conforms to any service interface output message that has been mapped to it. This implies that the implementation will be able to receive any message that the interface allows as input, and only sends messages that the interface allows as output. Determining whether this condition is satisfied is likewise straightforward.

Message-sequencing compliance requires that any sequence of flows into and out of the selected role that is permitted by the process model or protocol state machine implies a sequence of associated input and output messages that conforms to the messages exchange patterns of the operations in the service interface. Verifying that this condition is satisfied is not trivial. To date, however, there are as yet no effective and efficient techniques for determining whether message-sequencing compliance is satisfied.

### SUMMARY OF THE INVENTION

The present invention is directed to systems and methods for determining whether message sequences comprising an interaction between two roles described by a process model or protocol state machine comply with a given service interface for one of the two roles. To this end, the present invention is also directed to constructing an implementation protocol given (1) a protocol state machine for the partner interaction that describes the possible sequences of inbound and outbound messages, which can be derived from the process model if that is how the partner interaction is originally described; (2) protocol state machines representing message exchange patterns of the operations of a service interface, and (3) an implementation mapping that maps input and output message definitions in the service interface to message flows into and out of the process role, or transitions of the protocol state machine, representing inbound and outbound messages of the implementation.

From the construction of the implementation protocol it can be determined whether (a) when a transition in the process role's protocol (i.e., the partner interaction protocol) that corresponds to an inbound message is ready to occur, there is at least one matching transition in the service interface protocol under the implementation mapping that can also occur at this point in time (i.e., whether the inbound flow, when ready to be received by the process role, has been associated with at least one input message of an interface operation by the implementation mapping that can be used at that point in time), (b) when a transition of the partner interaction protocol that corresponds to an outbound message is ready to occur, there is exactly one transition in the service interface protocol under the implementation mapping that can also occur at this point (i.e., whether the outbound flow can be uniquely attributed to an output message in the service interface that can convey it at that point in time) and whether (c) in each final state of the implementation protocol all operation protocols are in final states (i.e., no operation is left “in progress” when the partner interaction has completed). If those conditions are satisfied, then the message sequence given by the process model or partner interaction protocol state machine complies with the message exchange patterns of the service interface operations under the given implementation mapping.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of an implementation mapping used in constructing an implementation protocol, according to one embodiment of the invention.

FIG. 2 is a schematic overview of a procedure for generating an implementation protocol given an implementation mapping, according to one embodiment of the invention.

FIG. 3 is a flowchart of exemplary steps in a procedure for generating an implementation protocol, according to one embodiment of the invention.

FIGS. 4A and 4B are flowcharts of exemplary steps in procedures for constructing a partner interaction protocol from a process model and, as part of this construction, generating an execution state graph for the process model, respectively, according to one embodiment of the invention.

FIGS. 5A and 5B are flowcharts of exemplary steps in a procedure for constructing an implementation protocol, according to one embodiment of the invention.

FIG. 6 is a schematic view of a system for constructing an implementation protocol, according to one embodiment of the invention.

FIG. 7 illustrates an exemplary process model.

FIG. 8A illustrates a partner interaction protocol for the supplier role of the process model shown in FIG. 7.

FIG. 8B shows the protocols for message exchange patterns of interface operations, which can be used for constructing implementation protocols for the process model shown in FIG. 7 given candidate service interfaces and implementation mappings.

FIG. 9 is an exemplary implementation protocol constructed according to embodiments of the invention.

FIG. 10 is another exemplary implementation protocol constructed according to the embodiments of the invention.

FIG. 11 is yet another exemplary implementation protocol constructed according to the embodiments of the invention.

FIG. 12 is still another exemplary implementation protocol constructed according to the embodiments of the invention.

FIG. 13 is another exemplary implementation protocol constructed according to the embodiments of the invention.

FIG. 14 is yet another exemplary implementation protocol constructed according to the embodiments of the invention.

FIG. 15 is still another exemplary implementation protocol constructed according to the embodiments of the invention.

### DETAILED DESCRIPTION

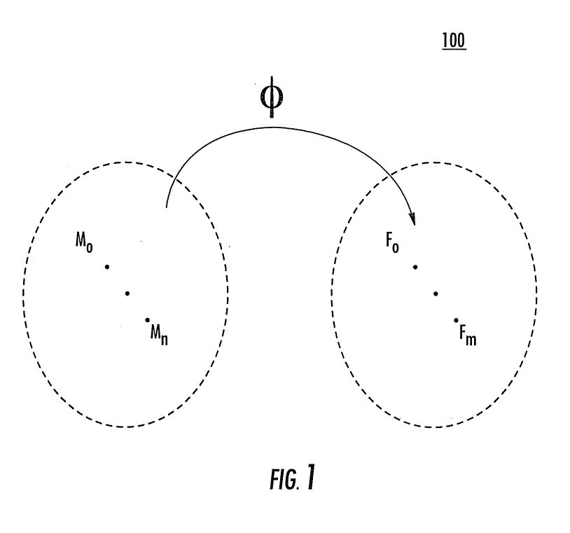

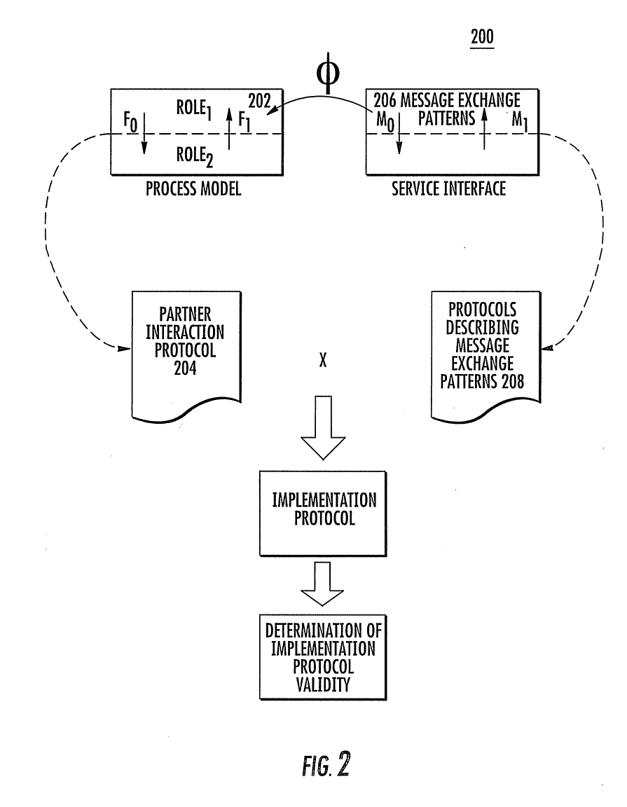

FIG. 1 is a schematic view of an implementation mapping, which maps a set of input/output messages {M_0, M_1, . . . }, as defined by a service interface, such as a WSDL interface, onto a set of flows {F_0, F_1, . . . } into and out of a process segment (or, more generally, any partner implementation for which an interaction protocol is known). Given the mapping φ, the implementation protocol corresponding to this mapping can be obtained according to the algorithmic-based procedures described herein. A high-level view of the procedure is schematically illustrated in FIG. 2. As shown, for a given process model 202, a partner interaction protocol 204, which can be represented using a protocol state machine, describes the possible sequences of inbound and outbound messages across the boundary of a process role. Message exchange patterns 206 given by the operations of a service interface can also be represented by one or more protocol state machines 208. The implementation protocol 210, constructed according to the procedures described herein, is a product of the partner interaction protocol 204 and the protocols 208 of the interface operations, wherein partner interaction protocol transitions corresponding to inbound and outbound message flows are matched with protocol transitions of the interface operations corresponding to input and output message definitions using the implementation mapping.

From the construction of the implementation protocol the following can be determined: whether each transition in the partner interaction protocol that describes an inbound message corresponds to (under the implementation mapping) at least one input transition in the protocol of the service interface that is ready to occur at this point of the interaction; whether each transition in the partner interaction protocol that describes an outbound message corresponds to (under the implementation mapping) exactly one output transition in the protocol of the service interface that is ready to occur at this point of the interaction; and whether, in each final state of the implementation protocol (the product of the partner interaction protocol 204 and the protocols 208 of the interface operations), all operation protocols are in their final states, that is, whether there is no operation that remains incomplete when the partner interaction has completed. If each transition in the partner interaction protocol that corresponds to an inbound message can be triggered by at least one input message through the interface when the transition is ready to occur, and each transition in the partner interaction protocol that corresponds to an outbound message can be associated with exactly one output message through the interface when the transition is ready to occur, and if, in each final state of the implementation protocol, all operation protocols are in their final states, then the partner interaction behavior given by the process model (or, equivalently, by the partner interaction protocol derived from it) complies with the message exchange patterns prescribed by the interface, under the given implementation mapping, φ.

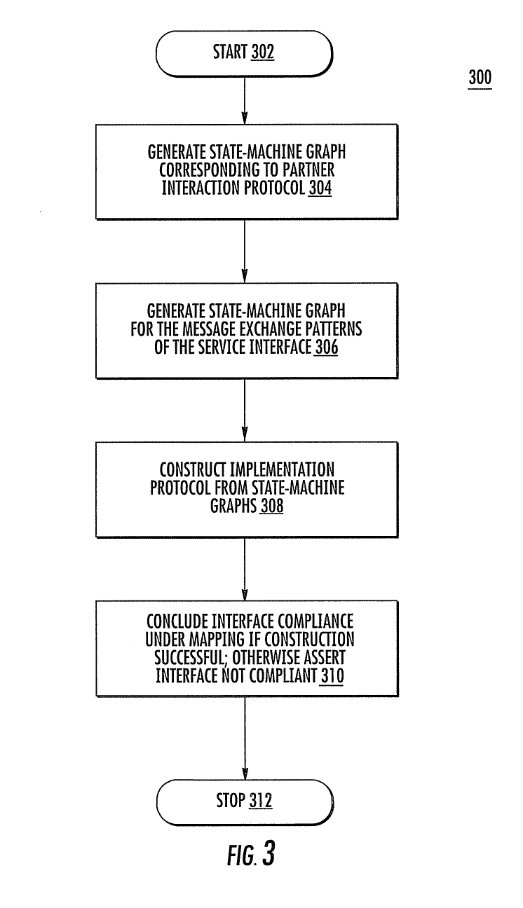

Referring now to FIG. 3, a process 300 for determining whether a partner interaction behavior, described via either a process model or a protocol state machine, is a valid implementation of a service interface is illustrated. In the process each of the following is given: (a) a partner interaction protocol describing possible sequences of messages between interacting partners; if the partner interaction is described using a multi-party process model, the partner interaction protocol can be derived from the process graph; (b) a service interface protocol representing the message exchange patterns corresponding to operations of the service interface; and (c) an implementation mapping that maps the message definitions in the service interface to flows into and out of the process role (or, equivalently, state transitions of the partner interaction protocol representing such flows). The procedure 300, after an the initial step 302, includes generating a state-machine graph representing the partner interaction protocol from a process model at step 304. (If that protocol is given, this step can be skipped.) At step 306, a state-machine graph for message exchange patterns corresponding to operations of the service interface is obtained. (Similarly, if these protocols are given as part of the interface definition, this step can be skipped.) From the state machine graphs, an implementation protocol is constructed at step 308. It shows, for all possible message sequences between the interacting partners, which interface operation inputs and outputs are used as these messages are being exchanged. At step 310 the validity of the implementation under the mapping is determined. More particularly, this determination comprises determining from the implementation protocol whether each of the operations completes in a final state and whether each inbound message of the implementation corresponds to at least one, and each outbound message to one and only one, input or output message respectively, of an interface operation. The process 300 illustratively concludes at step 312.

Each state-machine graph representing a partner interaction protocol comprises a sequence of one or more execution states of the partner interaction. If the protocol was derived from a process graph, then each execution state is given by a placement of tokens on the nodes and arcs of the process graph. A token on a node indicates that an execution of the node is in progress. A token on an arc indicates that a transmission of control along the arc is in progress. An initial execution state is a state with only one token on a node having no predecessor. A final execution state is one in which all tokens are on final nodes (that is, ones having no successors). State transitions occur as a token moves from a node to an outbound flow, or from an inbound flow to a node in the process graph.

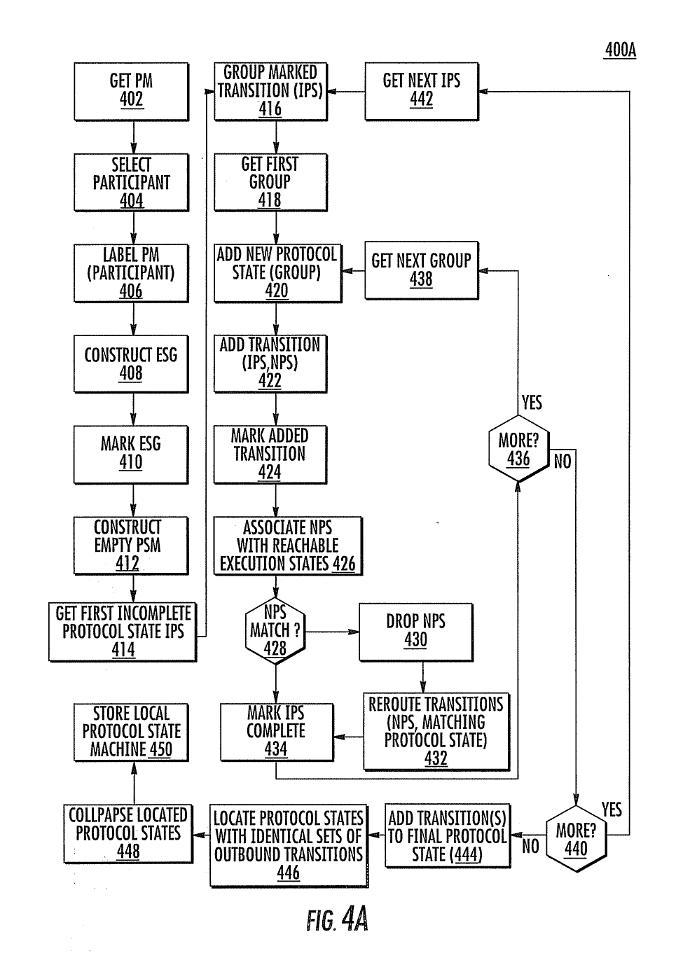

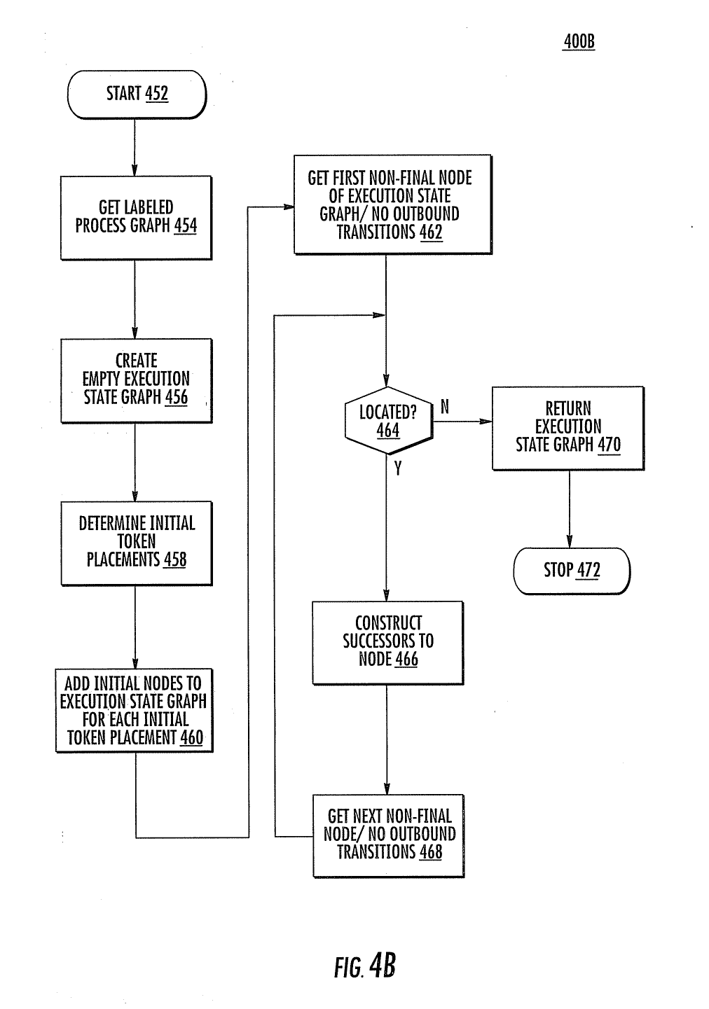

The generation of the state-machine graphs representing the partner interaction protocol from a multi-party process model can be performed using the procedures shown in FIGS. 4A, 4B. FIG. 4A is a flow chart illustrating a process for constructing a partner interaction protocol for a role (“swimlane”) in a multi-party process. Beginning in step 402, a process model can be selected and in step 404, a participant in the process model can be chosen for whom a local protocol is to be derived. In step 406, each node and arc in the process model can be labeled. For instance, for an arc crossing into or exiting from the swimlane for the chosen participant, two labels can be established. The first label can refer to the segment of the arc within the swimlane and the second label can refer to the segment of the arc external to the swimlane. Also, the same label that has been applied to an arc can also be applied to an adjacent node when the arc represents the only inbound flow into the node, or the only outbound flow from the node and the node is not a join.

In step 408, an execution state graph (ESG) for the labelled process is constructed, using the algorithm of FIG. 4B. While an ESG is also a state machine, it is referred to herein as “execution state graph” to avoid confusion with the protocol state machine that is eventually derived from the ESG.

Referring additionally to FIG. 4B, a flow chart is shown illustrating a process for constructing an execution state graph for a labeled process. After the start at step 452, a process graph that has been labeled as described previously can be retrieved for processing at step 454. In step 456, an en empty execution state graph can be generated, and at step 458, a set of all initial token placements for the process graph can be determined. At step 460, an initial node can be added to the empty execution state graph for each initial token placement in the set and each node can be associated with a corresponding token placement in the set. A first non-final node in the execution state graph can be located at step 462 subject to the condition that the located node has no outgoing transitions and has not been marked as final. A node in the execution state graph is considered final, when all tokens of its associated token placement are on final nodes of the process graph.

Subsequently, in the decision step 464, if a node can be found in the execution state graph that meets the condition, then successors to the node can be constructed at step 466. All immediate successor token placements to the placement associated with the located node can be found. If a successor placement is found that is already associated with an existing node in the execution state graph, a transition can be added to that node. Otherwise, a new node can be added to the execution state graph, the newly-added node corresponding to the successor placement, and a transition can be added from the located node to the added node. If an immediate successor placement to the one corresponding to the located node cannot be found, then the located node can be marked final. At step 468, a next non-final node can be located, again, subject to the condition that the located ode has no outgoing transitions and has not been marked final. If, at decision step 464, another node can be located that meets the condition, then the process of constructing successors to the node can repeat. Otherwise, the creation of the execution state graph is complete and the completed graph can be returned at step 470. The procedure illustratively concludes at step 472. The procedure can also be performed to determine the execution state graph for the message exchange patterns of a service interface, if these patterns are given in the form of process models with two participants.

Referring again to the flow of FIG. 4A, in block 410, the newly constructed execution state graph can be marked for both send and receive transitions. Specifically, each transition of the execution state graph that corresponds to a token movement out of the swimlane of the chosen participant can be marked “send <label>” where <label> is the label of the participant's internal segment of the arc from which the token leaves the swimlane. Similarly, each transition of the execution state graph that corresponds to a token movement into the participant's swimlane can be marked “receive <label>” where <label> is the label of the external segment of the arc from which the token enters the participant's swimlane. These markings can be restricted to execution state graph transitions that correspond to flows in the range of the implementation mapping φ, that is, to the set {F_0, F_1, . . . } in FIG. 1.

In block 412, an empty protocol state machine can be constructed from the execution state graph. To construct a protocol state machine from the execution state graph, an initial pseudo-state can be established and an unlabeled transition can connect the initial pseudo-state to a first protocol state. The first protocol state can be associated with all initial states of the execution state graph, and all execution states that can be reached transitively from an initial execution state via unmarked transitions. The resulting initial protocol state-machine will have one state, which has not been marked completed. Thereafter, in block 414, a first incomplete protocol state can be retrieved for processing.

In block 416, all marked transitions leaving from any of the incomplete protocol state's associated execution states can be located and grouped by their marking. Subsequently, in block 418, a first group can be selected for processing. In block 420, a new protocol state can be added for the group. Additionally, in block 422 a transition can be added from the incomplete protocol state to the new protocol state. Yet further in block 424 the added transition can be marked in the same way as the grouped transitions that were selected in block 418. Finally, in block 426 the new protocol state can be associated with the execution states that are the targets of the transitions grouped in block 418 as well as all execution states that can be reached transitively from those through unmarked execution state graph transitions.

In decision block 428, it can be determined whether the new protocol state matches an existing protocol state in that the new protocol state has the same set of associated execution states. If so, in block 430 the new protocol state can be dropped from the protocol state machine and in block 432, the inbound transitions to the dropped protocol state can be re-routed to the existing protocol state matching the dropped protocol state. Finally, in block 434 the incomplete protocol state can be marked complete if no additional groups of marked transitions from that state are to be processed. In decision block 436, if additional groups remained to be processed, the next group can be selected for processing in block 438 and the flow can repeat through block 420.

When no further groups of marked execution state graph transitions remain to be processed as determined within decision block 436, in decision block 440, it can be determined whether additional protocol states that have not yet been marked complete remain to be processed. If so, in block 442, the next incomplete protocol state can be retrieved and in block 416, once again different marked transitions can be grouped together and processed in blocks 418 through block 438.

In decision block 440, when no further incomplete protocol states remain, in block 444 a transition can be added to a final pseudo-state from any protocol state that is associated with a final state in the execution state graph. Also, in block 446 any subsets of protocol states having identical outbound transitions can be located and in block 448, each of these sets can be collapsed into a new state, which is associated with the union of the execution states of the protocol states that were collapsed to form it, and becomes the target of any of the collapsed states' inbound transitions. In executing block 446, two outbound transitions are considered identical when they have the same target state and the same “send <label>” or “receive <label>” marking (which was added in block 424). Finally, in block 450, the local protocol state machine can be stored in association with the swimlane of the participant whose partner interaction protocol was to be constructed.

Given a set of service operations and an implementation mapping φ from these operations' input and output message definitions to the inbound and outbound message flows of a partner interaction, the implementation protocol for this mapping can now be constructed using the partner interaction protocol as a starting point. Each state S of the implementation protocol comprises a state of the partner interaction protocol, annotated (augmented) by the states of interface operations in progress at this point of the interaction, where the latter states are taken from the protocol state machines describing these operations' message exchange patterns. The initial state of the implementation protocol is the initial state of the partner interaction protocol, with no operations in progress.

For each state S in the implementation protocol the outbound transitions and successor states are constructed by considering each transition t′ leaving the state S′ in the partner interaction protocol that corresponds to S; t′ signifies the occurrence of a flow between the interacting partners, that is, a flow across the segment (or role) boundary in the process model. One or more interface messages (operation inputs, operation outputs, and/or faults) correspond to this flow under the implementation mapping φ. Given the state of all interface operations in state S, at least one operation must be ready to supply an inbound flow, and exactly one to convey an outbound flow. If no qualifying input message is found for an inbound flow, or none or more than one output message that could convey an outbound flow, the implementation mapping is deemed invalid. Thus, for validity, a qualifying interface message definition is chosen and associated with a new state transition t, leaving state S, in the implementation protocol. If more than one qualifying input message can be chosen, then a new state transition t, leaving state S, can be created for each such input message, and associated with that message, in the implementation protocol.

The target state T of the transition t comprises the target state T′ of the corresponding transition t′ in the partner interaction protocol, wherein, if the interface message advanced the protocol of the message exchange pattern of the corresponding operation to an intermediate state, that new state of the operation would be indicated in the annotation (augmentation) of T. An operation that was completed by the interface message and does not permit any further (optional) messages to occur is no longer shown in the target state.

The procedure can continue until the construction has completed. Because there is only a finite number of partner interaction protocol states and operation states, only a finite number of implementation protocol states are possible, and, in practice, only a small subset of these will occur in the course of the construction. Thus, the construction procedure ends after a finite number of steps.

A state S of the implementation protocol is final if and only if the corresponding state S′ of the partner interaction protocol is a final state. In a final state of the implementation protocol, any operation state with which it has been annotated must be final as well; that is, there can be no mandatory interface messages that remain to be sent or received. Otherwise, the third dynamic compliance, or validity condition, of the implementation mapping is violated.

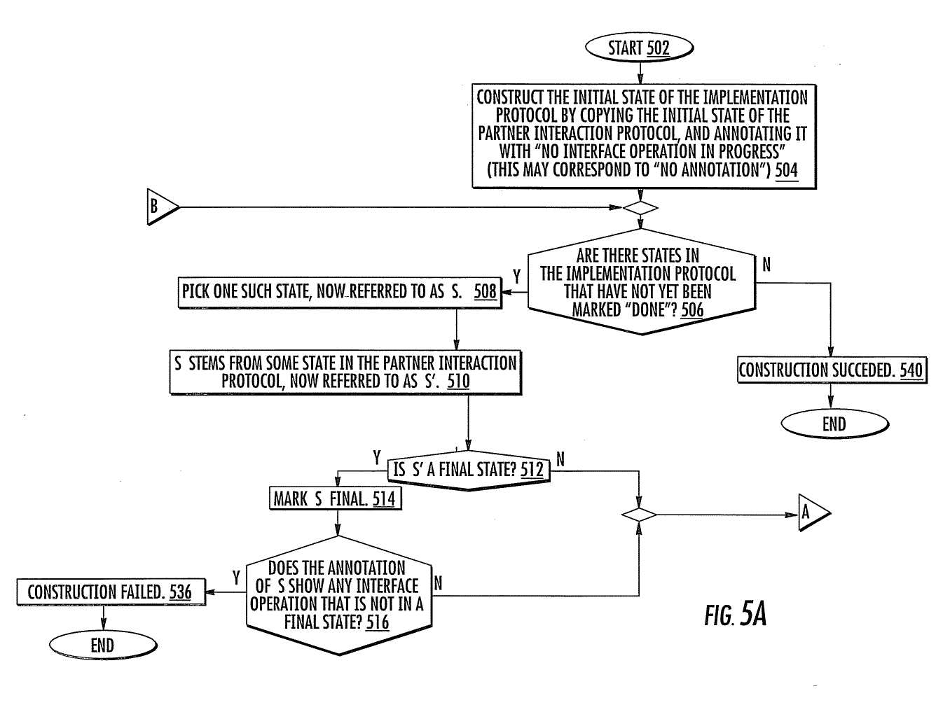

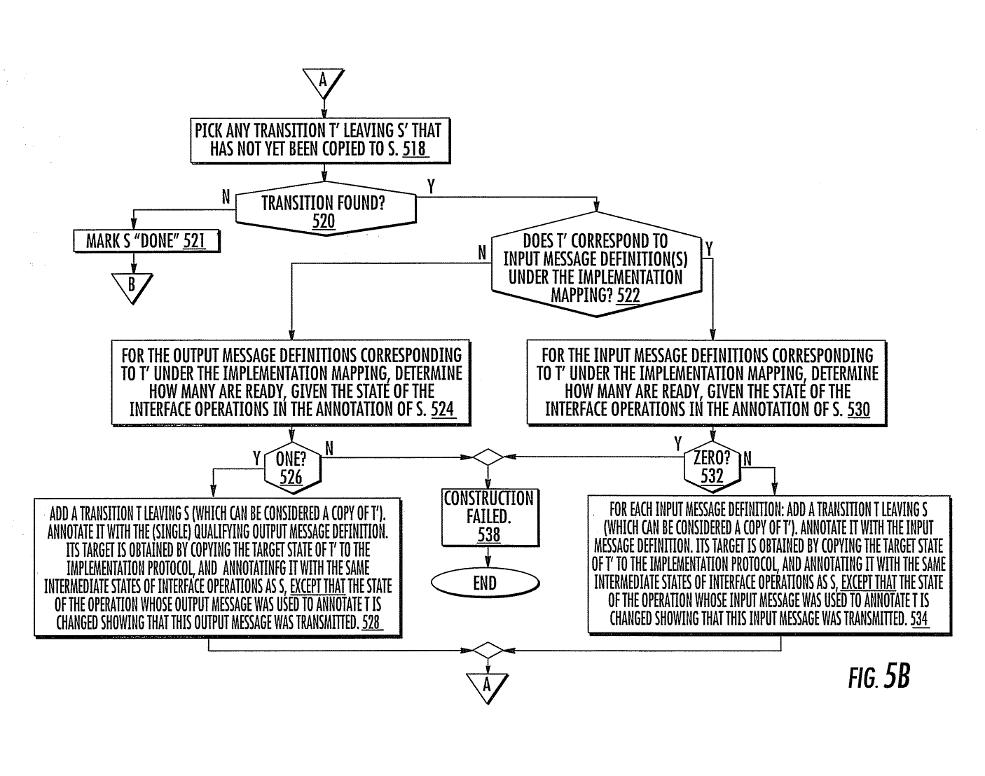

An algorithmic-based procedure for constructing an implementation protocol under a given implementation mapping is shown in FIGS. 5A and 5B. After the start, at step 502, the initial state of the implementation protocol is constructed at step 504. The initial state is constructed by copying the initial state of the partner interaction protocol, and annotating it with “no interface operation in progress” (this can correspond to “no annotation”). At decision step 506 is determined whether there are states in the implementation protocol that have not been marked “done.” If there are states that have not been so marked, then procedure continues to step 508 and one of these states, S, is selected; otherwise, the construction has succeeded (step 540) and the procedure ends. When a new state, S, has been selected, it stems from some state S′ in the partner interaction protocol, which is identified at step 510. At step 512 it is determined whether S′ is a final state. If S′ is not a final state, the procedure continues at step 518. Otherwise the procedure continues to step 514 where S is marked as final and the procedure continues to decision step 516. At decision step 516, it is determined whether the annotation of S indicates any interface operation that is not in a final state. If the annotation of S indicates that at least one interface operation is not in a final state (that is, some mandatory messages for this operation have not occurred), then the construction has failed (step 536) and the procedure ends. If the annotation does not indicate that an interface operation is not in a final state, then the procedure continues at step 518.

At step 518, any transition t′ leaving S′ that has not yet been copied to S is selected. It is determined at decision step 520 whether such a transition is found. If not, then at step 521 the state S is marked “done” and the procedure returns to step 506. If, however, such a transition t′ is found, then at decision step 522 it is determined whether t′ corresponds to one or more input message definitions under the implementation mapping.

If t′ does not correspond to one or more input messages definitions under the implementation mapping, the procedure continues to step 524 (t′ then is known to correspond to one or more output message definitions). At step 524, for the output message definition or definitions corresponding to t′ under the implementation mapping, it is determined how many are ready, given the state of the interface operations in the annotation of S. If exactly one is ready, determined at decision step 526, then at step 528 a transition t leaving S is added (t can be considered a copy of t′). The transition is annotated with the (single) qualifying output message definition. Its target is obtained by copying the target state of t′ from the partner interaction protocol to the implementation protocol and annotating it with the same intermediate states of interface operations as S, except that the state of the operation whose output message was used to annotate t is changed to show that this output message was transmitted. The procedure then returns to step 518. However, if at decision step 526 it is determined that zero, or more than one, output message definitions corresponding to t′ are ready given the state of all interface operations in the annotation of S, then the construction fails (step 538) and the procedure ends.

When t′ does correspond to one or more input message definitions under the implementation mapping, as determined at decision step 522, then the procedure continues to step 530. At step 530, for the input message definitions corresponding to t′ under the implementation mapping, it is determined how many are ready, given the state of the interface operations in the annotation of S. If it is determined at decision step 532 that zero are ready, then the construction fails (step 538) and the procedure ends. Otherwise, at step 534, for each such input message definition, a transition t leaving S is added (which, again, can be considered a copy of t′). It is annotated with the input message definition. Its target is obtained by copying the target state of t′ to the implementation protocol and annotating it with the same intermediate states of interface operations as S, except that the state of the operation whose input message was used to annotate t is changed to show that this input message was transmitted. The procedure then returns to step 518. After a finite number of iterations, either the construction has failed (step 536 or step 538) or the procedure will have successfully constructed a valid implementation protocol (step 540).

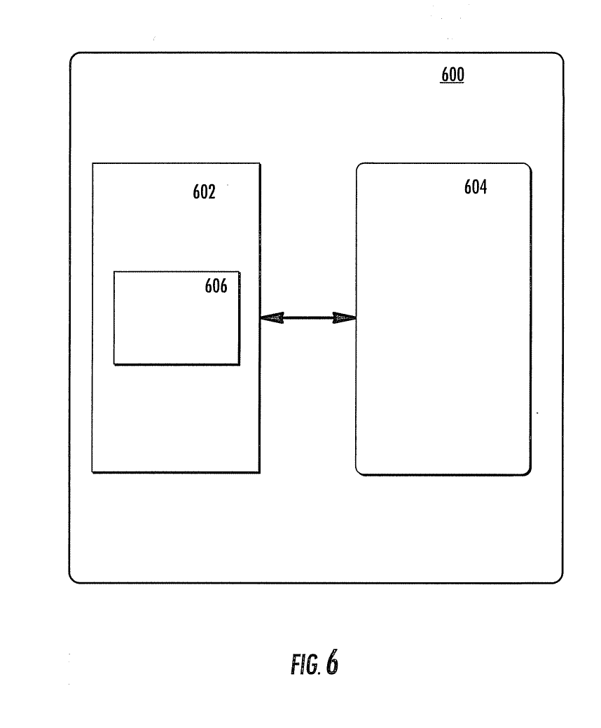

Referring now to FIG. 6, a system 600 for constructing an implementation protocol, according to one embodiment of the invention, is schematically illustrated. The system 600 illustratively includes one or more processors 602. The one or more processors can be implemented in logic-based circuitry, including a plurality of registers and logic gates (not explicitly shown). The system also illustratively includes a memory 604 communicatively linked to the one or more processors. The memory 604 can store data processing instructions that when loaded to the one or more processors 602 cause the one or more processors to process data stored, in the memory and conveyed to the one or more processors. The system 600 further includes an implementation-protocol generating module 606 that executes on the one or more processors 602.

More particularly, the implementation-protocol generating module 606 is configured to implement the above-described procedures so as to generate a state-machine graph representing the partner interaction protocol for two interacting partners, to generate at least one state-machine graph representing message exchange patterns corresponding to operations of a given service interface, and to construct from the state-machine graphs an implementation protocol that defines how the operations of the service interface are used for any sequence of message flows between the interacting partners.

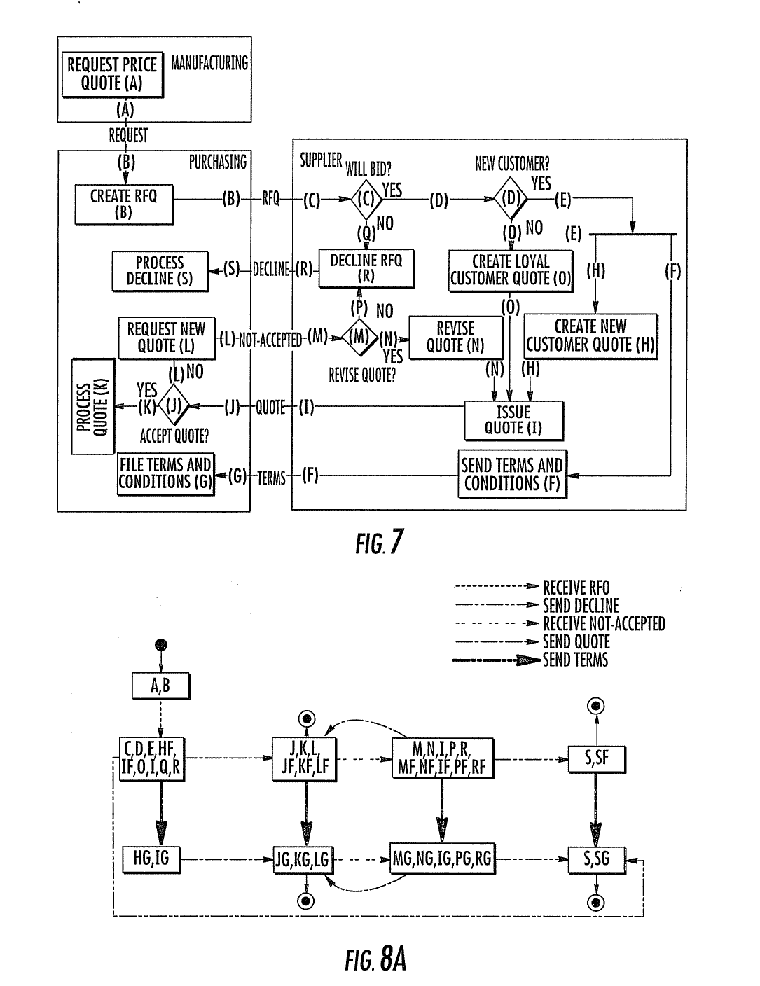

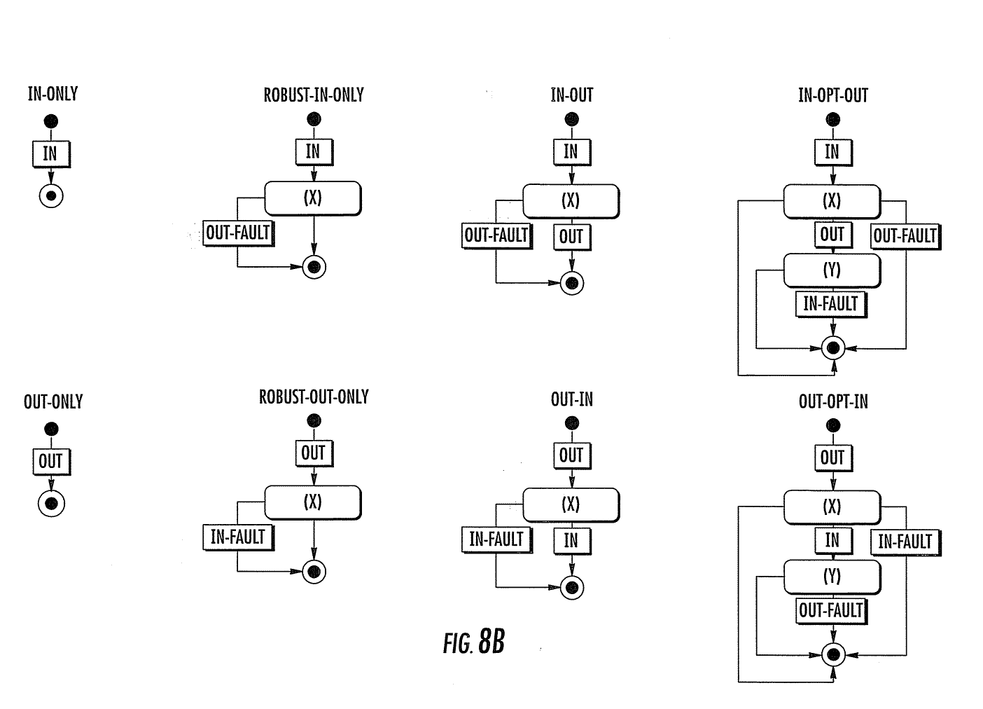

The operative features of the invention can be illustrated in the context of a request-for-quote (RFQ) interaction, focusing on the a supplier's interface as seen from the perspective of a purchasing partner. The process is represented by the process model shown in FIG. 7. The partner interaction protocol of the supplier segment is shown in FIG. 8A.

The set F of inter-segment messages is thus given by the five flows, RFQ, decline, notAccepted, quote, and terms. The following is a first choice of an exemplary WSDL 2.0 interface (WSDL Interface 1) for the supplier:

```
<interface name=“i1” >
  <operation name=“op1” pattern=“http://www.w3.org/2006/01/wsd1/
  in-only” >
    <input messageLabel=“In” element=“ns:RFQ” />
  </operation>
  <operation name=“op2” pattern=“http://www.w3.org/2006/01/wsd1/
  in-only” >
    <output messageLabel =“Out” element=“ns:decline” />
  </operation>
<operation name=“op3” pattern=“http://www.w3.org/2006/01/wsd1/
in-only” >
  <input messageLabel=“In” element=“ns:notAccepted” />
  </operation>
<operation name=“op4” pattern=“http://www.w3.org/2006/01/wsd1/
out-only” >
  <output messageLabel=“Out” element=“ns:quote” />
  </operation>
<operation name=“op5” pattern=“http://www.w3.org/2006/01/wsd1/
out-only” >
  <output messageLabel=“Out” element=“ns:terms” />
  </operation>
</interface>
```

In this and the following WSDL interfaces, the names of the XML element references defining input, output, or fault messages (for example, element=“ns:RFQ”) imply the implementation mapping: Above, for example, the input of operation ‘op1’ is mapped to the ‘RFQ’ flow in FIG. 7, the output of operation ‘op2’ to the ‘decline’ flow, etc. Similar naming conventions have been used for all of the following WSDL interfaces.

The WSDL 2.0 standard defines eight possible message exchange patterns for interface operations: in-only, robust-in-only, in-out, in-opt-out, out-only, robust-out-only, out-in, out-opt-in. The corresponding protocol state machines are shown in FIG. 8B. They will be used in the construction of the implementation protocols for this and the following examples.

WSDL interface 1 defines five one-way operations, corresponding to the five messages between purchasing and the supplier. The operations for the RFQ and notAccepted messages are in-only operations, the remaining three operations are out-only. The message exchange pattern of this interface permits any operation to be called at any time.

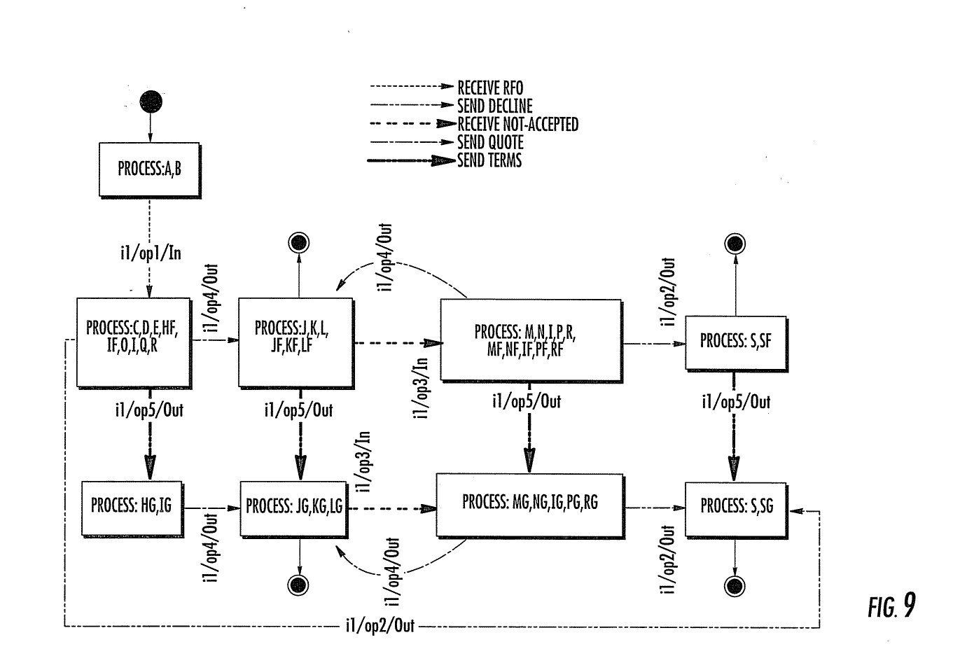

Because all operations are one-way, determining dynamic compliance is straightforward. For exposition, however, the implementation protocol generated by the above-described procedures is shown in FIG. 9. Unique interface messages can be associated with each transition, and all operations are complete in any final state. Accordingly, the supplier segment in the process graph in FIG. 7 represents a valid implementation of the exemplary interface (WSDL Interface 1) under this implementation mapping.

The following is another exemplary WSDL interface (WSDL Interface 2):

```
<interface name=“i2” >
  <fault name=“f1” element = “ns:decline” />
  <operation name=“op1” pattern=“http://www.w3.org/2006/01/wsd1/
  in-out” >
    <input messageLabel=“In” element =“ns:RFQ” />
    <output messageLabel=“Out” element =“ns:quote” />
    <outfault messageLabel=“Out” ref = “tns:f1” />
  </operation>
  <operation name=“op2” pattern = “http://www.w3.org/2006/01/wsd1/
  in-out” >
    <input messageLabel=“In” element = “ns:notAccepted” />
    <output messageLabel=“Out” element =“ns:quote” />
    <outfault messageLabel=“Out” ref = “tns:f1” />
  </operation>
  <operation name=“op3” pattern=“http://www.w3.org/2006/01/wsd1/
  out-only” >
    <output messageLabel=“Out” element =“ns:terms” />
  </operation>
</interface>
```

The interface defines two request-response operations, one taking an RFQ and returning a quote, and one taking a notAccepted message and returning a (revised) quote. Both operations specify an in-out message exchange pattern and an outbound fault message that may return a decline instead of the quote. A third operation, having an out-only message exchange pattern, permits sending terms and conditions at any time. Note that the implementation mapping in this example is not injective: the response message of both op1 and op2 has been mapped to the ‘quote’ flow, and the fault message of both operations has been mapped to the ‘decline’ flow. Interface compliance then requires that whenever one of these flows occurs, exactly one of the two operations (op1 or op2) is ready to convey the ‘quote’ flow as its response, or the ‘decline’ flow as its fault, respectively.

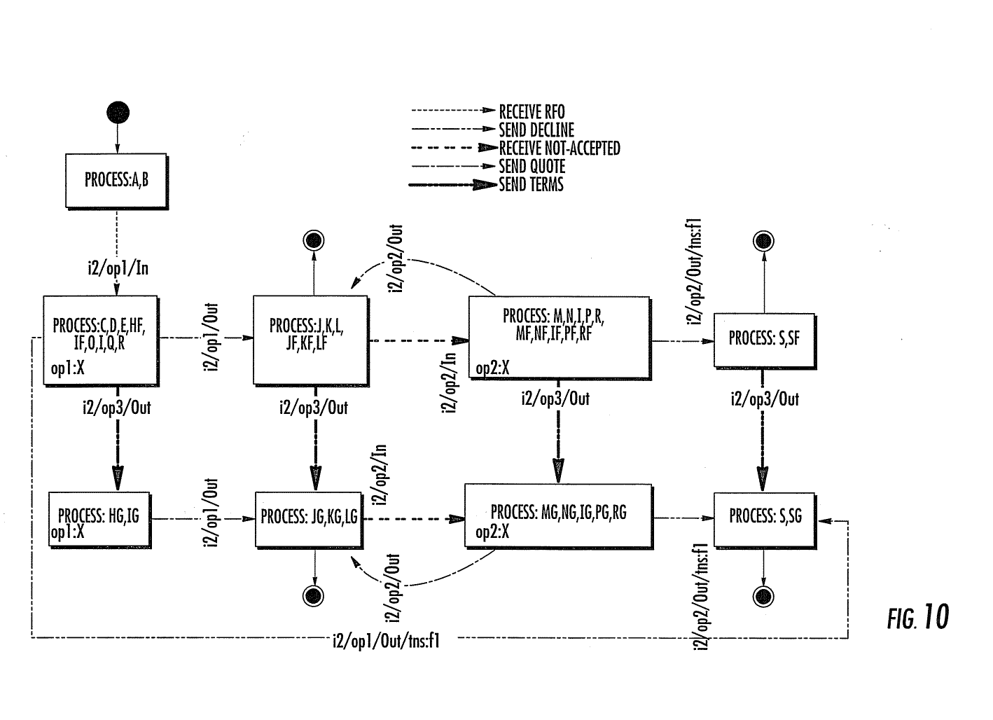

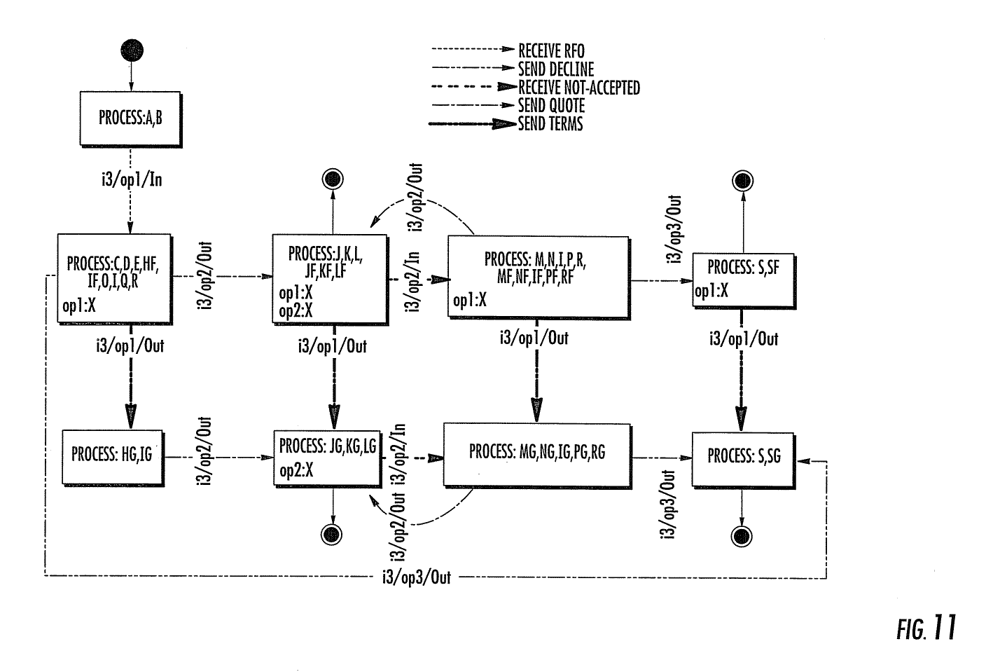

The implementation protocol is shown in FIG. 10. The initial state is the initial state of the supplier's partner interaction protocol, with no operations in progress. The initial state of the supplier's protocol has one outgoing transition, corresponding to an incoming RFQ, which is associated with the input of operation op1. The state transition in the implementation protocol is marked accordingly. In the target state of the transition, op1 is in an intermediate state X. At that point of the interaction, the supplier's partner interaction protocol offers three possible transitions that must be considered. They correspond to outbound flows for quote, decline, and terms and conditions. Any of these can occur next.

The flow for quotes in the process model is associated with the outputs of operation op1 or op2 under the implementation mapping. Only op1, however, is now in a state where its message exchange pattern allows its output to occur. Thus, there is a unique interface message that can be associated with the send quote transition. The state transition in the implementation protocol is marked accordingly. Note that in its target state (which corresponds to process execution states [J, K, L, JF, KF, LF]), op1 has completed and is no longer listed as an operation in progress. Similarly, the flow for decline messages in the process model is associated with the faults of op1 or op2 under the implementation mapping, but only op1 is ready to return a fault in the second state of the implementation protocol (FIG. 10). Thus, there is again a unique interface message that can be associated with a decline sent by the supplier at this point. And, again, op1 will have completed in the target state (which corresponds to process execution states [S, SG]).

The flow to send terms and conditions is associated with the output of op3 by the implementation mapping, which is a one-way (out-only) operation and therefore can be invoked at any time. Thus, there is also a unique interface message for the third transition leaving the second protocol state (corresponding to execution states [C, D, E, HF, IF, O, I, Q, R]). Note that in its target state (which corresponds to execution states [HG, IG]), the state of operation op1 has not changed; it is still in the intermediate state (marked ‘X’) and waiting to be completed, either through an output message or a fault.

The remaining transitions and target states in the implementation protocol (FIG. 10) are constructed in the same manner. Note that in the target states of the two “receive notAccepted” transitions, op2 is in progress while op1 has completed, and thus the quote and decline messages that can occur at that point of the interaction are now mapped to the output and fault messages, respectively, of op2.

All transitions (representing flow occurrences in the process model) can be associated with unique interface messages, and all operations have completed in any final state of the implementation protocol. Accordingly, the supplier process segment in FIG. 7 is a valid implementation of this interface (WSDL Interface 2) under the implementation mapping.

Following is a third exemplary WSDL interface (WSDL Interface 3):

```
<interface name = “i3” >
  <operation name = “op1” pattern = “http://www.w3.org/2006/01/wsd1/
  in-opt-out”>
    <input messageLabel = “In” element = “ns:RFQ” />
    <output messageLabel = “Out” element = “ns:terms” />
  </operation>
  <operation name = “op2” pattern = “http://www.w3.org/2006/01/wsd1/
  out-opt-in” >
    <output messageLabel = “Out” element = “ns:quote” />
    <input messageLabel = “In” element = “ns:notAccepted” />
  </operation>
  <operation name = “op3” pattern = “http://www.w3.org/2006/01/wsd1/
  out-only” >
    <output messageLabel = “Out” element = “ns:decline” />
  </operation>
</interface>
```

The interface defines a one-to-one mapping between the interface-defined messages and inter-segment flows in the process model, as did the first interface (WSDL Interface 1). It uses an in-opt-out operation for RFQs, which may be answered by terms and conditions, an out-opt-in operation for quotes, which may be answered by not-accepted messages, and an out-only operation for declines. No faults are provided.

The implementation protocol of the interface is shown in FIG. 11. The implementation mapping is injective, and thus, there is only one possible interface message to consider for each occurrence of a flow. It remains to be verified, however, that op1 and op2 are in their intermediate state whenever the flow that has been mapped to the output of op1 (terms and conditions) or the flow that has been mapped to the input of op2 (notAccepted) may occur. As is obvious in FIG. 11, the condition is always satisfied. Regarding termination, because the second messages of op1 and op2 are both optional, the conversation can end while they are in their intermediate states. For example, if an RFQ is answered by a quote that is accepted, and terms and conditions are not transmitted, then the conversation ends while both op1 and op2 are in their intermediate states (a transition to the final pseudo-state occurs from the protocol state that corresponds to the process execution states [J, K, L, JF, KF, LF]).

A fourth exemplary interface (WSDL 4) is given by the following:

```
<interface name = “i4” >
  <fault name = “f1” element = “ns:decline” />
  <operation name = “op1” pattern = “http://www.w3.org/2006/01/wsd1/
  in-opt-out” >
    <input messageLabel = “In” element = “ns:RFQ” />
    <output messageLabel = “Out” element = “ns:terms” />
    <outfault messageLabel = “In” ref = “tns:f1” />
  </operation>
<operation name = “op2” pattern = “http://www.w3.org/2006/01/wsd1/
out-opt-in” >
    <output messageLabel = “Out” element = “ns:quote” />
    <input messageLabel = “In” element = “ns:not Accepted” />
    <outfault messageLabel = “In” ref = “tns:f1” />
```

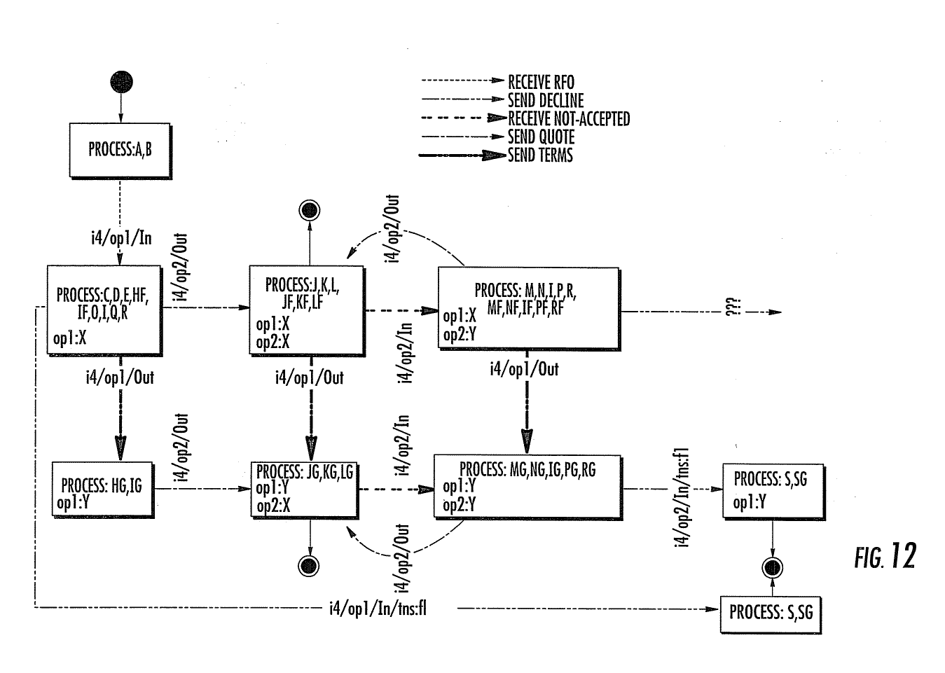

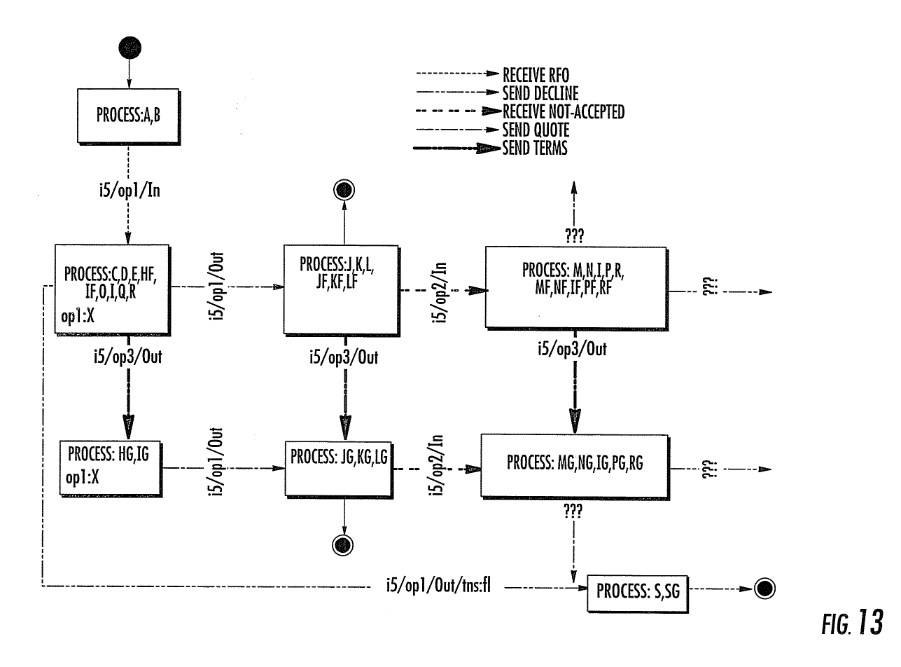

The WSDL 4 interface is similar to the WSDL 3 interface but the third operation has been “absorbed” into op1 and op2 by using out-faults for the decline message. The implementation protocol is shown in FIG. 12. As illustrated, a problem arises when an RFQ is followed by a quote that is not accepted: the implementation protocol is then in the state corresponding to the process execution states [M, N, I, P, R, MF, NF, IF, PF, RF] where both op1 and op2 are in progress, and the partner interaction is at a point where a decline message can be returned. The partner interaction protocol transition that corresponds to ‘send decline’ cannot be associated with a unique interface message, since it is not clear which of the two pending operations should return it. Because of this ambiguity, the implementation mapping is invalid.

Another phenomenon illustrated here is that the implementation protocol has two states derived from the single state in the partner interaction protocol (corresponding to process execution states [S, SG]). If the RFQ is immediately followed by a decline, the partner interaction protocol ends in that state and no operation is in progress because the decline message, which is returned as an out-fault of op1, terminates that operation. If the same state of the partner interaction protocol is reached through the sequence RFQ-quote-terms-notAccepted-decline, however, then op1 ends in state Y. Since a state of the implementation protocol is defined as a state of the partner interaction protocol annotated by zero or more intermediate states of interface operations in progress, these are different implementation protocol states.

Still another exemplary interface (WSDL Interface 5) is given by the following:

```
<interface name = “i5” >
  <fault name = “f1” element = “ns:decline” />
  <operation name = “op1” pattern = “http://www.w3.org/2006/01/wsd1/
  in-out” >
    <input messageLabel = “In” element = “ns:RFQ” />
    <output messageLabel = “Out” element = “ns:quote” />
    <outfault messageLabel = “Out” ref = “tns:f1” />
  </operation>
  <operation name = “op2” pattern = “http://www.w3.org/2006/01/wsd1/
  in-only” >
    <input messageLabel = “In” element = “ns:notAccepted” />
  </operation>
  <operation name = “op3” pattern = “http://www.w3.org/2006/01/wsd1/
  out-only” >
    <output messageLabel = “Out” element = “ns:terms” />
  </operation>
</interface>
```

The messages in this interface are mapped to the flows between purchasing and supplier in a one-to-one fashion: An in-out operation takes an RFQ as input and responds with either a quote or a decline message, which is returned as a fault. Two additional one-way operations cover the notAccepted message (inbound) and the terms and conditions message (outbound). This interface and its implementation mapping could have been motivated by the following, albeit erroneous, reasoning: An RFQ is answered by either a quote (normal response) or by a decline (fault). An in-out operation with a fault can cover these three flows. Moreover, the supplier must be able to send out terms and conditions (an out-only operation can be added to provide for this message) and purchasing must be able to reject a quote (an in-only operation can be added to provide this). After a notAccepted message has been sent to the supplier, however, no further operation is available to return a revised quote or decline. Thus, it is expected that the algorithm ends with a non-compliance result.

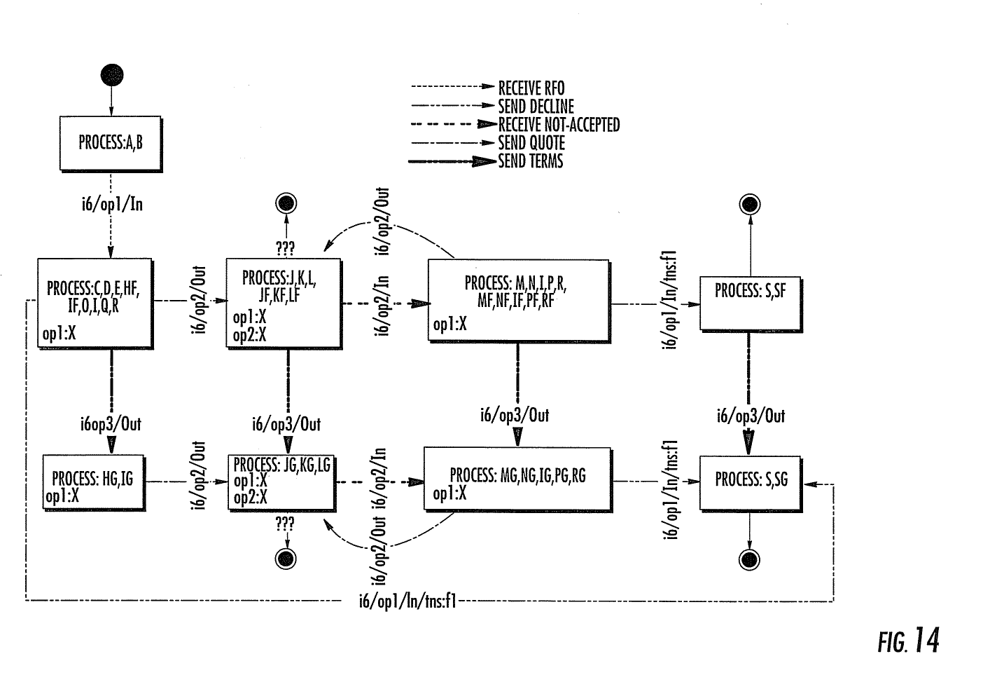

The implementation protocol for this example is shown in FIG. 13.

Construction of the implementation protocol for this interface and implementation mapping will fail, as expected and shown in FIG. 13. After an RFQ is received, op1 is in its intermediate state. If the RFQ is answered by a quote, the operation ends. The quote can then be followed by a notAccepted message, passed via the in-only operation op2. The process now allows that the supplier sends a revised quote or decline. The interface operations, however, are now in a state where no outbound quote or decline can be passed. The corresponding transitions (leaving the protocol states [M, N, I, P, R, MF, NF, IF, PF, RF] and [MG, NG, IG, PG, RG]) therefore cannot be associated with any interface operations. Accordingly, the implementation mapping is invalid, and the interface is not compliant with the dynamics of the process model.

The following provides yet another exemplary interface (WSDL Interface 6):

```
<interface name = “i6” >
    <fault name = “f1” element = “ns:decline” />
    <operation name = “op1” pattern = “http://www.w3.org/2006/01/
    wsd1/robust-in-only” >
      <input messageLabel = “In” element = “ns:RFQ” />
      <outfault messageLabel = “In” ref = “tns:f1” />
    </operation>
    <operation name = “op2” pattern = “http://www.w3.org/2006/01/
    wsd1/out-in” >
      <output messageLabel = “Out” element = “ns:quote” />
      <input messageLabel = “In” element = “ns:notAccepted” />
    </operation>
    <operation name = “op3” pattern = “http://www.w3.org/2006/01/
    wsd1/out-only” >
      <output messageLabel = “Out” element = “ns:terms” />
    </operation>
  </interface>
```

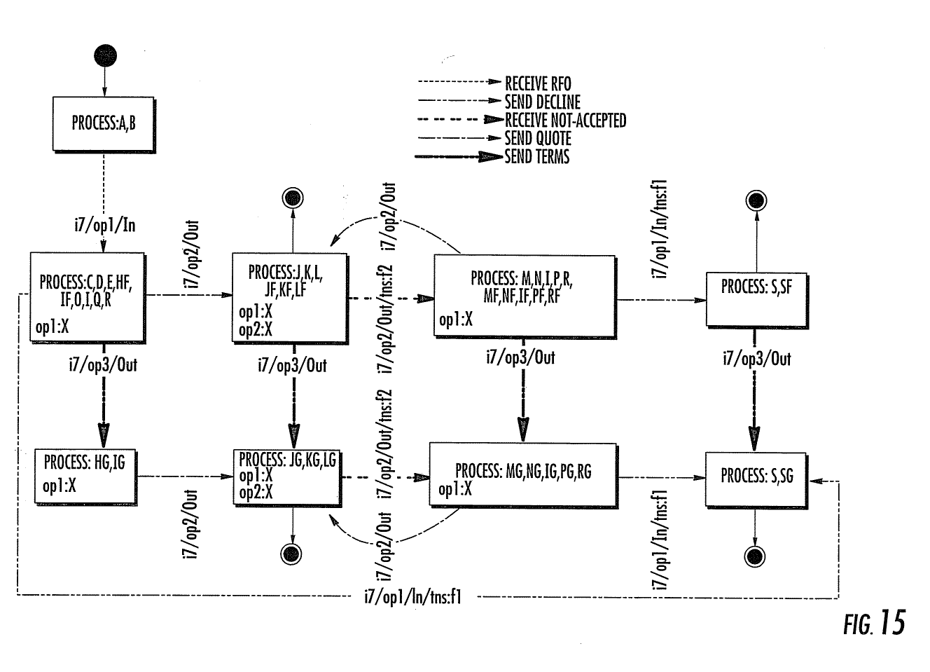

The implementation protocol is shown in FIG. 14. the interface defines five messages, and a one-to-one implementation mapping to the five flows between purchasing and the supplier. All flow occurrences (protocol transitions) can be associated with interface messages in an unambiguous fashion, but semantic compliance is violated at protocol termination: The process can end after an RFQ and a single quote have been exchanged, but at that point op2 will be in its intermediate state X, which is not a final state for an out-in operation; it will wait indefinitely for its mandatory input message (notAccepted). To resolve the dilemma, this input can be made optional, as demonstrated in the next example.

The following is another exemplary interface (WSDL Interface 7), which addresses the problem described with respect to the previous one:

```
<interface name = “i7” >
    <fault name = “f1” element = “ns:decline” />
    <fault name = “f2” element = “ns:notAccepted” />
    <operation name = “op1” pattern = “http://www.w3.org/2006/01/
    wsd1/robust-in-only” >
      <input messageLabel = “In” element = “ns:RFQ” />
      <outfault messageLabel = “In” ref = “tns:f1” />
    </operation>
    <operation name = “op2” pattern = “http://www.w3.org/2006/01/
    wsd1/robust-out-only” >
      <output messageLabel = “Out” element = “ns:quote” />
      <infault messageLabel = “Out” element = ref =tns:f2” />
    </operation>
    <operation name = “op3” pattern = “http://www.w3.org/2006/01/
    wsd1/out-only” >
      <output messageLabel = “Out” element = “ns:terms” />
    </operation>
  </interface>
```

The implementation protocol is shown in FIG. 15. The problem found with respect to the previous interface has been solved by substituting a robust-out-only operation for the out-in operation op2. The resulting implementation protocol reveals that since the intermediate states of op1 and op2 are both final, all transitions to final are now legal transitions.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

I claim:

1. A method for determining whether a dynamic model for the interaction of two parties, which can be given as a process model or protocol state machine, is compliant with a service interface defined for one party, given (a) a partner interaction protocol describing the possible sequences of messages exchanged between the interacting parties, (b) a service interface protocol describing the message exchange patterns of the operations of the service interface, and (c) an implementation mapping from the input and output messages defined in the service interface to inbound and outbound flows of the selected party, the method comprising:
generating state-machine graphs representing: the partner interaction protocol of the two interacting parties, and the message exchange patterns corresponding to operations of the service interface;
constructing from the state-machine graphs an implementation protocol, the implementation protocol indicating the manner in which operations of the service interface are used for any possible sequence of messages flows permitted by the partner interaction protocol;
determining from the implementation protocol whether each of the operations completes in a final state, whether each inbound flow of the selected party, when it is ready to be received according to the partner interaction protocol, can be accepted via at least one input message of the interface, and whether each outbound flow of the selected party, when it can occur according to the partner interaction protocol, can be transmitted via exactly one output message of the interface.

2. The method of claim 1, wherein determining whether each inbound flow that is ready to be received corresponds to at least one input message of an interface operation that is ready to be accepted at this point comprises determining whether each transition of the partner interaction protocol corresponding to an inbound message matches at least one transition in the service interface protocol corresponding to an input message; and wherein determining whether each outbound flow that is ready to be sent corresponds to exactly one output message of an interface operation that is ready to be transmitted at this point comprises determining whether each transition of the partner interaction protocol corresponding to an outbound message matches exactly one transition in the service interface protocol corresponding to an output message.

3. The method of claim 1, wherein generating the state-machine graph representing the partner interaction protocol of two process roles comprises:
labeling the process model defining the process roles;
constructing and marking an execution-state graph from the labeled process model;
constructing the state-machine graph from the execution-state graph; and
pruning the state machine graph by dropping redundant states.

4. The method of claim 3, wherein constructing and marking the execution-state graph comprises:
creating an empty execution-state graph for the labeled process model;
determining initial token placements for the labeled process model;
adding initial nodes for each initial token placement to the execution state graph; and
constructing successor nodes in the execution-state graph for each node of the execution-state graph that has no outgoing transitions and has not been marked final.

5. The method of claim 4, where constructing successor nodes for each node that has no outgoing transitions and that has not been marked final comprises:
locating, for an existing node of the execution-state graph having no outgoing transitions, all immediate successor placements for the associated token placement;
adding a transition to the existing node responsive to locating immediate successor placements to its associated token placement and finding a second existing node in the execution-state graph corresponding to an immediate successor placement and otherwise adding a new node corresponding to this immediate successor placement; and a transition from the existing node to one of the second existing node or the new node; and
otherwise making the existing node as final where no immediate successor placements for the associated token placement can be found.

6. The method of claim 1, wherein constructing the implementation protocol comprises:
generating at least one state of the implementation protocol that comprises a state of the partner interaction protocol annotated by zero or more intermediates states of operations that are in progress;
associating a single input or output message definition of an interface operation with each transition in the implementation protocol, such that, given the state of the interface operation in the annotation of the source state of that transition, the input or output message induces a permitted state transition of the operation; and
annotating the target state of an implementation protocol transition with the target state of the operation after passing the inbound or outbound message that has been associated with the transition.

7. The method of claim 6, wherein, given a transition leaving a state of the implementation protocol and its associated inbound or outbound message flow, the state of the interface operations in the annotation of this implementation protocol state is such that, if the associated flow is outbound, exactly one of the operations is ready to transmit an output message corresponding to this flow under the implementation mapping, and if the associated flow is inbound, at least one of the operations is ready to accept an input message corresponding to this flow under the implementation mapping.

8. The method of claim 6, wherein, given the states of all operations in the annotation of a state of the implementation protocol, if zero or more than one operation are ready to transmit an outbound message flow that is associated with a transition leaving this state, or no operation is ready to accept an inbound message flow that is associated with a transition leaving this state, then the partner interaction described by the process model or protocol state machine is determined to not represent a valid implementation of the service interface.

9. The method of claim 6, wherein a state of the implementation protocol is final if and only if a corresponding state of the partner interaction protocol is final.

10. The method of claim 9, wherein, if a state of the implementation protocol is final, then every operation state in its annotation is also final; and wherein the method further comprises signaling that the implementation mapping is invalid if at least one operation state is not final.

11. A system for constructing an implementation protocol given (a) a partner interaction protocol describing possible sequences of messages between two interacting parties, (b) one or more protocols of message exchange patterns of operations of a service interface, and (c) an implementation mapping that maps the input and output messages of the service interface to messages between the two interacting parties, the system comprising:
at least one processor; and
an implementation-protocol generating module that executes on the at least one processor;
wherein the implementation-protocol generating module is configured to generate a state-machine graph representing the partner interaction protocol, to generate at least one state-machine graph representing message exchange patterns corresponding to operations of the service interface, and to construct from the state-machine graphs an implementation protocol that defines which operations of the service interface are used for any sequence of message flows of the process role.

12. A computer-readable medium in which computer readable-code is embedded that when loaded to and executed by computer causes the computer to determine whether a dynamic model for the interaction of two parties, which can be given as a process model or protocol state machine, is compliant with a service interface defined for one party, given (a) a partner interaction protocol describing the possible sequences of messages exchanged between the interacting parties, (b) a service interface protocol describing the message exchange patterns of the operations of the service interface, and (c) an implementation mapping from the input and output messages defined in the service interface to inbound and outbound flows of the selected party, the method comprising:
generating state-machine graphs representing: the partner interaction protocol of the two interacting parties, and the message exchange patterns corresponding to operations of the service interface;
constructing from the state-machine graphs an implementation protocol, the implementation protocol indicating the manner in which operations of the service interface are used for any possible sequence of messages flows permitted by the partner interaction protocol;
determining from the implementation protocol whether each of the operations completes in a final state, whether each inbound flow of the selected party, when it is ready to be received according to the partner interaction protocol, can be accepted via at least one input message of the interface, and whether each outbound flow of the selected party, when it can occur according to the partner interaction protocol, can be transmitted via exactly one output message of the interface.

13. The computer-readable medium of claim 12, wherein determining whether each inbound flow that is ready to be received corresponds to at least one input message of an interface operation that is ready to be accepted at this point comprises determining whether each transition of the partner interaction protocol corresponding to an inbound message matches at least one transition in the service interface protocol corresponding to an input message; and wherein determining whether each outbound flow that is ready to be sent corresponds to exactly one output message of an interface operation that is ready to be transmitted at this point comprises determining whether each transition of the partner interaction protocol corresponding to an outbound message matches exactly one transition in the service interface protocol corresponding to an output message.

14. The computer-readable medium of claim 12, wherein generating the state-machine graph representing the partner interaction protocol of two process roles comprises:
labeling the process model defining the process roles;
constructing and marking an execution-state graph from the labeled process model;
constructing the state-machine graph from the execution-state graph; and
pruning the state machine graph by dropping redundant states.

15. The computer-readable medium of claim 14, wherein constructing and marking the execution-state graph comprises:
creating an empty execution-state graph for the labeled process model;
determining initial token placements for the labeled process model;
adding initial nodes for each initial token placement to the execution state graph; and
constructing successor nodes in the execution-state graph for each node of the execution-state graph that has no outgoing transitions and has not been marked final.

16. The computer-readable medium of claim 15, where constructing successor nodes for each node that has no outgoing transitions and that has been marked final comprises:
locating, for an existing node of the execution-state graph having no outgoing transitions, all immediate successor placements for the associated token placement;
adding a transition to the existing node responsive to locating immediate successor placements to its associated token placement and finding a second existing node in the execution-state graph corresponding to an immediate successor placement and otherwise adding a new node corresponding to this immediate successor placement; and a transition from the existing node to one of the second existing node or the new node; and
otherwise marking the existing node as final where no immediate successor placements for the associated token placement can be found.

17. The computer-readable medium of claim 12, wherein constructing the implementation protocol comprises:
generating at least one state of the implementation protocol that comprises a state of the partner interaction protocol annotated by zero or more intermediates states of operations that are in progress;
associating a single input or output message definition of an interface operation with each transition in the implementation protocol, such that, given the state of the interface operation in the annotation of the source state of that transition, the input or output message induces a permitted state transition of the operation; and
annotating the target state of an implementation protocol transition with the target state of the operation after passing the inbound or outbound message that has been associated with the transition.

18. The computer-readable medium of claim 17, wherein, given a transition leaving a state of the implementation protocol and its associated inbound or outbound message flow, the state of the interface operations in the annotation of this implementation protocol state is such that, if the associated flow is outbound, exactly one of the operations is ready to transmit an output message corresponding to this flow under the implementation mapping, and if the associated flow is inbound, at least one of the operations is ready to accept an input message corresponding to this flow under the implementation mapping.

19. The computer-readable medium of claim 17, wherein, given the states of all operations in the annotation of a state of the implementation protocol, if zero or more than one operation are ready to transmit an outbound message flow that is associated with a transition leaving this state, or no operation is ready to accept an inbound message flow that is associated with a transition leaving this state, then the partner interaction described by the process model or protocol state machine is determined to not represent a valid implementation of the service interface.

20. The computer-readable medium of claim 17, wherein a state of the implementation protocol is final if and only if a corresponding state of the partner interaction protocol is final.

21. The computer-readable medium of claim 20, wherein, if a state of the implementation protocol is final, then every operation state in its annotation is also final; and wherein the method further comprises signaling that the implementation mapping is invalid if at least one operation state is not final.
